(19) United States
(12) Patent Application Publication
(10) Pub. No.: US 2026/0122372 A1
(43) Pub. Date: Apr. 30, 2026

(54) IMAGE SENSOR

(71) Applicant: SAMSUNG ELECTRONICS CO., LTD., Suwon-si (KR)

(72) Inventor: Jiwon PARK, Suwon-si (KR)

(73) Assignee: SAMSUNG ELECTRONICS CO., LTD., Suwon-si (KR)

(21) Appl. No.: 19/327,578

(22) Filed: Sep. 12, 2025

(30) Foreign Application Priority Data
Oct. 28, 2024 (KR) 10-2024-0148747

(51) Int. Cl. H04N 25/77; H04N 23/67; H04N 25/704

(52) U.S. Cl. CPC H04N 25/77; H04N 23/672; H04N 25/704

(57) ABSTRACT

Provided is an image sensor including: a pixel array including a plurality of pixel groups arranged in a matrix, wherein the pixel array is configured to output a pixel signal; a row driver configured to transmit a control signal to the plurality of pixel groups; and a readout circuit configured to output an image signal based on the pixel signal, wherein a first pixel group of the plurality of pixel groups includes a plurality of pixels sharing a floating diffusion region, wherein a first pixel of the plurality of pixels of the first pixel group includes a first photodiode, a second photodiode, a first transfer transistor, a second transfer transistor, and a switching transistor, wherein the first transfer transistor and the second transfer transistor are controlled by a transfer control signal, and wherein the second transfer transistor receives the transfer control signal through the switching transistor.

### CROSS-REFERENCE TO RELATED APPLICATION

This U.S. non-provisional application claims priority to Korean Patent Application No. 10-2024-0148747, filed in the Korean Intellectual Property Office on Oct. 28, 2024, the disclosure of which is incorporated herein by reference in its entirety.

### BACKGROUND

### 1. Field

The present disclosure relates to an image sensor and an operating method of the image sensor. Specifically, the present disclosure relates to an image sensor supporting auto focus and a method of operating the image sensor.

### 2. Description of Related Art

An image sensor is a device capable of converting an optical image into an electrical signal. Image sensors are classified into charge-coupled device (CCD) image sensors and complementary metal-oxide-semiconductor (CMOS) image sensors.

An auto focusing (AF) function that automatically detects focus is being utilized in imaging devices. Phase difference auto focusing (PAF) adjusts a focus distance based on the phase difference of optical signals detected from different locations.

### SUMMARY

Provided is an image sensor operating in a plurality of auto focusing modes using a simplified structure of the image sensor, and a method of operating the image sensor.

According to an aspect of the disclosure, an image sensor includes: a pixel array including a plurality of pixel groups arranged in a matrix, wherein the pixel array is configured to output a pixel signal; a row driver configured to transmit a control signal to the plurality of pixel groups; and a readout circuit configured to output an image signal based on the pixel signal, wherein a first pixel group of the plurality of pixel groups includes a plurality of pixels sharing a floating diffusion region, wherein a first pixel of the plurality of pixels of the first pixel group includes a first photodiode, a second photodiode, a first transfer transistor, a second transfer transistor, and a switching transistor, wherein the first transfer transistor and the second transfer transistor are controlled by a transfer control signal, and wherein the second transfer transistor receives the transfer control signal through the switching transistor.

According to an aspect of the disclosure, an image sensor includes: a pixel array including a plurality of pixel groups arranged in a matrix, wherein the pixel array is configured to output a pixel signal, and wherein the plurality of pixel groups includes a first pixel group; a row driver configured to transmit a control signal to the plurality of pixel groups; and a readout circuit configured to output an image signal based on the pixel signal, wherein each of the plurality of pixel groups includes a plurality of pixels sharing a floating diffusion region, wherein the plurality of pixels of the first pixel group includes a first pixel and a second pixel adjacent to each other in a row direction of the matrix, wherein the first pixel includes a first photodiode, a second photodiode, a first transfer transistor, a second transfer transistor, and a first switching transistor, wherein the first transfer transistor and the second transfer transistor are configured to respectively transfer photocharges of the first photodiode and the second photodiode to the floating diffusion region based on a first transfer control signal, wherein the first switching transistor is configured to provide the first transfer control signal to the second transfer transistor, wherein the second pixel includes a third photodiode, a fourth photodiode, a third transfer transistor, a fourth transfer transistor, and a second switching transistor, wherein the third transfer transistor and the fourth transfer transistor are configured to respectively transfer photocharges of the third photodiode and the fourth photodiode to the floating diffusion region based on a second transfer control signal, wherein the second switching transistor is configured to provide the second transfer control signal to the fourth transfer transistor, wherein the first switching transistor and the second switching transistor are controlled by a switching control signal, and wherein the first transfer control signal and the second transfer control signal are provided by different signal lines.

According to an aspect of the disclosure, an image sensor includes: a pixel array including a plurality of pixel groups arranged in a matrix, wherein the pixel array is configured to output a pixel signal; a row driver configured to transmit a control signal to the plurality of pixel groups; and a readout circuit configured to output an image signal based on the pixel signal, wherein each of the plurality of pixel groups includes a plurality of pixels sharing a floating diffusion region, wherein, for each of the plurality of pixel groups, each pixel of the plurality of pixels includes a plurality of photodiodes and a plurality of transfer transistors, wherein each of the plurality of transfer transistors connects one of the plurality of photodiodes to the floating diffusion region, wherein, for each of the plurality of pixel groups, the plurality of transfer transistors of each pixel of the plurality of pixels are controlled by a transfer control signal, wherein, for each of the plurality of pixel groups, one of the plurality of transfer transistors of each pixel of the plurality of pixels is controlled by the transfer control signal, and wherein, for each pixel of the plurality of pixels of each of the plurality of pixel groups, the transfer control signal is received through a switching transistor.

### BRIEF DESCRIPTION OF THE DRAWINGS

The above and other aspects and features of certain embodiments of the present disclosure will be more apparent from the following description taken in conjunction with the accompanying drawings, in which:

FIG. 1 is a block diagram of an image sensor according to one or more embodiments of the present disclosure;

FIG. 2 is a circuit diagram of a pixel group according to one or more embodiments of the present disclosure;

FIG. 3 shows connections of some transistors and wirings of a pixel array according to one or more embodiments of the present disclosure;

FIGS. 4, 5 and 6 show timing diagrams of an image sensor for reading out pixel signals in different auto focusing modes of the pixel array of FIG. 3;

FIG. 7 shows connections of some transistors and wirings of a pixel array according to one or more embodiments of the present disclosure;

FIG. 8 shows a pixel array according to one or more embodiments of the present disclosure;

FIG. 9 shows a simplified pixel array according to one or more embodiments of the present disclosure;

FIG. 10 is a circuit diagram of a pixel group according to one or more embodiments of the present disclosure;

FIG. 11 shows connections of some transistors and wirings of a pixel array according to one or more embodiments of the present disclosure;

FIGS. 12 and 13 are block diagrams of an image sensor according to embodiments of the present disclosure; and

FIG. 14 is a block diagram of an electronic device according to one or more embodiments of the present disclosure.

### DETAILED DESCRIPTION

Hereinafter, embodiments of the present disclosure will be described clearly and in detail so that those skilled in the art may practice the present disclosure.

In the following description, like reference numerals refer to like elements throughout the specification. Terms such as “unit”, “module”, “member”, and “block” may be embodied as hardware or software. As used herein, a plurality of “units”, “modules”, “members”, and “blocks” may be implemented as a single component, or a single “unit”, “module”, “member”, and “block” may include a plurality of components.

It will be understood that when an element is referred to as being “connected” with or to another element, it can be directly or indirectly connected to the other element, wherein the indirect connection may include “connection via a wireless communication network”.

Also, when a part “includes” or “comprises” an element, unless there is a particular description contrary thereto, the part may further include other elements, not excluding the other elements.

Throughout the description, when a member is “on” another member, this includes not only when the member is in contact with the other member, but also when there is another member between the two members.

As used herein, the expressions “at least one of a, b or c” and “at least one of a, b and c” indicate “only a,” “only b,” “only c,” “both a and b,” “both a and c,” “both b and c,” and “all of a, b, and c.”

It will be understood that, although the terms “first”, “second”, “third”, etc., may be used herein to describe various elements, is the disclosure should not be limited by these terms. These terms are only used to distinguish one element from another element.

As used herein, the singular forms “a,” “an” and “the” are intended to include the plural forms as well, unless the context clearly indicates otherwise.

With regard to any method or process described herein, an identification code may be used for the convenience of the description but is not intended to illustrate the order of each step or operation. Each step or operation may be implemented in an order different from the illustrated order unless the context clearly indicates otherwise. One or more steps or operations may be omitted unless the context of the disclosure clearly indicates otherwise.

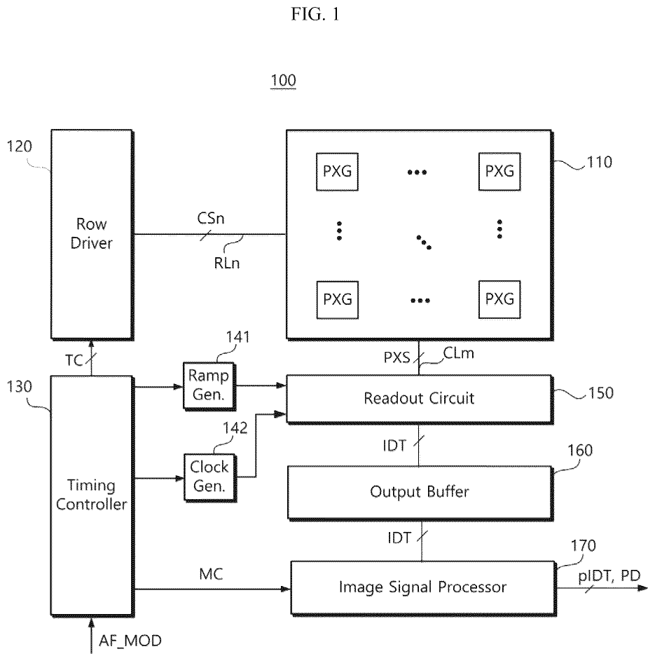

FIG. 1 is a block diagram showing an image sensor 100 according to one or more embodiments of the present disclosure.

The image sensor 100 according to one or more embodiments of the present disclosure may operate a pixel group PXG according to the performance of an auto focusing function of an imaging device. The pixel group PXG may operate differently in a plurality of different auto focusing modes.

The image sensor 100 according to one or more embodiments of the present disclosure may include a pixel array 110, a row driver 120, a timing controller 130, a ramp generator 141, a clock generator 142, a readout circuit 150, an output buffer 160, and an image signal processor 170.

The pixel array 110 may include a plurality of pixel groups PXGs. The plurality of pixel groups PXGs may be arranged in, for example, a matrix form. Each of the pixel groups PXGs may include a plurality of pixels. Each of the plurality of pixels may include one or more photoelectric conversion elements. In one or more embodiments, each of the plurality of pixels may include two photoelectric conversion elements.

The pixel array 110 may receive a plurality of pixel driving signals CSn such as a selection signal, a reset signal, and a transfer control signal through a plurality of row lines RLn from the row driver 120. The pixel array 110 may operate according to the control of the received pixel driving signals CSn.

Each of the pixels of the image sensor 100 may convert an optical signal into an electrical signal through the photoelectric conversion element. In addition, a pixel signal PXS based on the pixels or the pixel groups may be transmitted to the readout circuit 150 through a plurality of column lines CLm. The readout circuit 150 may include an analog-to-digital converter.

In one or more embodiments, the photoelectric conversion element may be a photodiode (PD). The photodiode PD may a type of photoelectric conversion element that generates charges in proportion to light signal incident on each pixel and accumulates the generated charges.

In one or more embodiments, the photoelectric conversion element may be one of the photodiode (PD), a photocapacitor, a photogate, a pinned photodiode (PPD), a partially pinned photodiode, an organic photodiode (OPD), and a quantum dot (QD), or a combination thereof.

Embodiments of the present disclosure will be described on the assumption that the photoelectric conversion element is a PD, but the above-mentioned other photoelectric conversion elements may be used and the photoelectric conversion elements as referred to herein are not limited to a PD.

Each of the pixels of the image sensor 100 according to one or more embodiments of the present disclosure may include a plurality of photoelectric conversion elements. Each of the pixels may include two photoelectric conversion elements. The plurality of photoelectric conversion elements of each of the pixels may be disposed adjacent to each other in either a column direction (a direction in which a column extends) or a row direction (a direction in which a row extends) of the pixel array 110. The embodiments of the present specification will be described on the assumption that the plurality of photoelectric conversion elements of each pixel are disposed adjacent to each other in the column direction of the pixel array 110. However, the present disclosure does not exclude that the plurality of photoelectric conversion elements of each pixel are disposed adjacent to each other in the row direction or another direction of the pixel array 110.

Photocharges accumulated in at least two photoelectric conversion elements of each pixel may be independently transferred to a floating diffusion region or transferred to the floating diffusion region during the same period according to each of the plurality of auto focusing modes.

In one or more embodiments, each of the plurality of pixels may include one microlens, and the plurality of photoelectric conversion elements of the same pixel may share one microlens.

In one or more embodiments, each of the plurality of pixel groups PXGs may include one microlens, and the plurality of pixels of the same pixel group PXG may share one microlens.

The embodiments of the present specification will be described on the assumption that each of the plurality of pixels includes one microlens. However, the present disclosure does not exclude that each of the plurality of pixel groups PXGs shares one microlens.

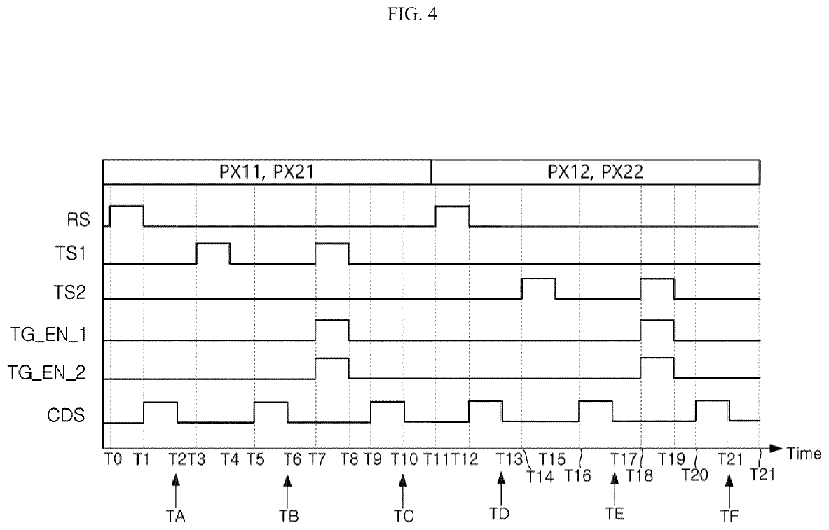

The row driver 120 may select at least one row of the pixel array 110 according to the control of the timing controller 130. The row driver 120 may generate a selection signal to select at least one row among the plurality of rows. The row driver 120 may activate the pixels corresponding to the selected row. The row driver 120 may transmit control signals to the plurality of pixels based on an operation mode of the image sensor. For example, the row driver 120 may provide a transfer control signal, a reset control signal, and a switching control signal to the plurality of pixels. The row driver 120 may supply the control signals to the plurality of pixels through the row lines RLn. For example, the row driver 120 may provide the control signals to the plurality of pixels with the timing shown in FIGS. 4, 5, and 6, based on the operation mode of the image sensor. The pixel signals PXS sampled from the selected row pixels (or the pixel groups) may be transmitted to the analog-to-digital converter of the readout circuit 150. The pixel signal PXS may be any one of a reset level pixel signal that samples a reset voltage level of the floating diffusion region and a pixel level pixel signal that samples a pixel voltage level of the floating diffusion region.

The analog-to-digital converter of the readout circuit 150 may convert the reset voltage level pixel signal PXS and the pixel voltage level pixel signal PXS into a digital signal and output them. In the present specification, the reset voltage level pixel signal PXS may be used interchangeably with a reset level signal, and the pixel voltage level pixel signal PXS may be used interchangeably with a pixel level signal.

The analog-to-digital converter may sample the reset level signal and the pixel level signal using a correlated double sampling method and then convert the sampled signals into image data IDT that is a digital signal. A correlated double sampler (CDS) may be further disposed at a front end of the analog-to-digital converter.

The output buffer 160 may latch the digitally converted image data IDT of each column unit and transmit the latched image data IDT to the image signal processor 170. The output buffer 160 may temporarily store the image data IDT according to the control of the timing controller 130 and sequentially provide the latched image data IDT to the image signal processor 170.

The timing controller 130 may control the pixel array 110, the row driver 120, the readout circuit 150, and the image signal processor 170. The timing controller 130 may provide a timing control signal TC to the row driver 120. The timing controller 130 may provide a reference code to the readout circuit 150. The timing controller 130 may receive a control signal AF_MOD from an external device. In one or more embodiments, the external device may be an application processor of an electronic device. The timing controller 130 may provide a control signal and an auto focusing mode control signal MC to the image signal processor 170. The timing controller 130 may include a logic control circuit, a phase lock loop (PLL) circuit, and/or a timing control circuit, etc.

According to one or more embodiments, the image signal processor 170 may be implemented by software, hardware, or a combination of software and hardware. The image signal processor170 may process the image data IDT based on the auto focusing mode control signal MC and generate processed image data pIDT and phase data PD. The image signal processor 170 may output the processed image data pIDT and the phase data PD through an interface circuit. The image signal processor 170 is provided with the image data IDT. The image signal processor 170 may perform processing with respect to the image data IDT to output the processed image data pIDT. The processing may include crosstalk correction, auto dark level compensation (ADLC), digital gain processing, demosaicing, etc. Demosaicing may include color filter array(CFA) interpolation of the image data IDT.

An application processor of the imaging device may receive the image data and the phase data from the image sensor. The application processor may process the image data to display the processed image data on a display or save the processed image data as an image file. The application processor may perform a phase difference operation based on the phase data to calculate disparity. The application processor may perform auto focusing of a camera based on the disparity.

The row driver 120 of the image sensor 100 according to one or more embodiments of the present disclosure may differently operate the plurality of photoelectric conversion elements of each pixel according to the auto focusing mode. The image sensor 100 may operate in a plurality of different auto focusing modes.

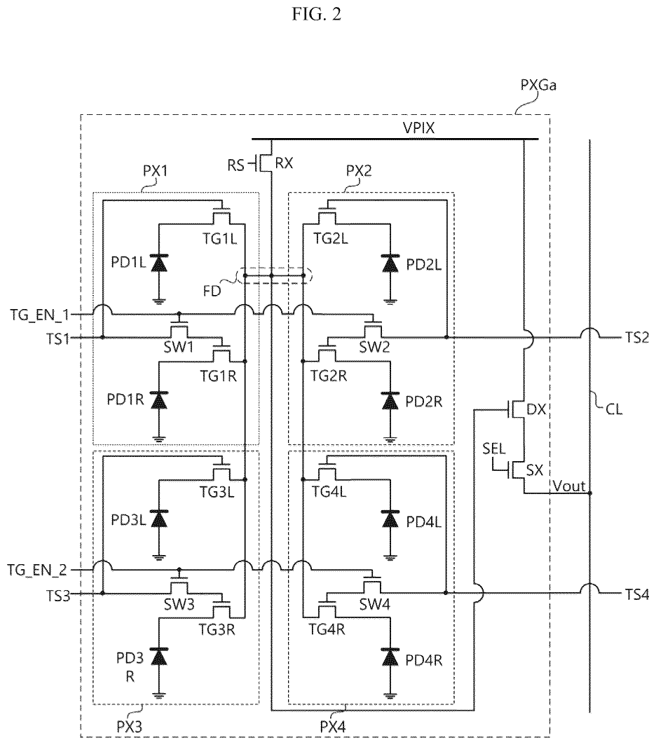

FIG. 2 shows a circuit diagram of a pixel group PXGa according to one or more embodiments of the present disclosure. The pixel group PXGa of FIG. 2 may correspond to the pixel group PXG of FIG. 1. A circuit configuration according to one or more embodiments of the pixel group PXGa will be described with reference to FIG. 2.

Referring to FIG. 2, the pixel group PXGa according to one or more embodiments of the present disclosure may include a plurality of pixels PX1, PX2, PX3, and PX4. FIG. 2 shows that the pixel group PXGa includes four pixels PX1, PX2, PX3, and PX4, but the present disclosure is not limited thereto, and the pixel group PXGa may include a different number of pixels.

The pixels PX1, PX2, PX3, and PX4 of the pixel group PXGa may share one floating diffusion region FD.

In one or more embodiments, the pixels PX1, PX2, PX3, and PX4 of the pixel group PXGa may share at least some pixel circuits.

For example, referring to in FIG. 2, the pixels PX1, PX2, PX3, and PX4 of the pixel group PXGa may share a reset transistor RX, a driving transistor DX, and a selection transistor SX.

In one or more embodiments, each of the pixels PX1, PX2, PX3, and PX4 may include two photoelectric conversion elements. The photoelectric conversion elements of each of the pixels PX1, PX2, PX3, and PX4 may be located adjacent to each other in the column direction.

In one or more embodiments, the photoelectric conversion elements of each of the pixels PX1, PX2, PX3, and PX4 may be connected to the same floating diffusion region FD through separate transfer transistors.

For example, a first photoelectric conversion element PD1L of a first pixel PX1 may be connected to the floating diffusion region FD through a first transfer transistor TG1L, and a second photoelectric conversion element PD1R may be connected to the floating diffusion region FD through a second transfer transistor TG1R. Similarly, first photoelectric conversion elements PD2L, PD3L, and PD4L of a second pixel PX2, a third pixel PX3, and a fourth pixel PX4 may be respectively connected to the floating diffusion region FD through first transfer transistors TG2L, TG3L, and TG4L. Second photoelectric conversion elements PD2R, PD3R, and PD4R of the second pixel PX2, the third pixel PX3, and the fourth pixel PX4 may be respectively connected to the floating diffusion region FD through second transfer transistors TG2R, TG3R, and TG4R.

In one or more embodiments, each of the pixels PX1, PX2, PX3, and PX4 may respectively receive transfer control signals TS1, TS2, TS3, and TS4 to control the transfer transistors TG1L, TG2L, TG3L, TG4L, TG1R, TG2R, TG3R, and TG4R. For example, the first pixel PX1 may receive the first transfer control signal TS1, and the second pixel PX2 may receive the second transfer control signal TS2. The third pixel PX3 may receive the third transfer control signal TS3, and the fourth pixel PX4 may receive the fourth transfer control signal TS4.

In one or more embodiments, the first transfer transistor TG1L and the second transfer transistor TG1R of the first pixel PX1 may be controlled by the first transfer control signal TS1. That is, a gate terminal of each of the first transfer transistor TG1L and the second transfer transistor TG1R of the first pixel PX1 may receive the first transfer control signal TS1 that is the same transfer control signal.

In one or more embodiments, the first transfer control signal TS1 may be directly transmitted to the first transfer transistor TG1L and transmitted to the second transfer transistor TG1R through a first switching transistor SW1. That is, the gate terminal of the second transfer transistor TG1R of the first pixel PX1 may receive the first transfer control signal TS1 in a turn-on state of the first switching transistor SW1. The first switching transistor SW1 may be controlled by a first switching control signal TG_EN_1.

In one or more embodiments, similar to the first pixel PX1, the second pixel PX2, the third pixel PX3, and the fourth pixel PX4 may be controlled. For example, the transfer transistors TG2L, TG3L, TG4L, TG2R, TG3R, and TG4R of the second pixel PX2, the third pixel PX3, and the fourth pixel PX4 may be controlled by the transfer control signals TS2, TS3, and TS4.

For example, the first transfer transistor TG2L and the second transfer transistor TG2R of the second pixel PX2 may be controlled by the second transfer control signal TS2. The first transfer transistor TG3L and the second transfer transistor TG3R of the third pixel PX3 may be controlled by the third transfer control signal TS3. The first transfer transistor TG4L and the second transfer transistor TG4R of the fourth pixel PX4 may be controlled by the fourth transfer control signal TS4.

In one or more embodiments, the second transfer control signal TS2 may be directly transmitted to the first transfer transistor TG2L of the second pixel PX2 and transmitted to the second transfer transistor TG2R through a second switching transistor SW2.

In one or more embodiments, the second switching transistor SW2 of the second pixel PX2 may be controlled by the same switching control signal as that of the first switching transistor SW1 of the first pixel PX1. For example, the first switching transistor SW1 of the first pixel PX1 and the second switching transistor SW2 of the second pixel PX2 may be controlled by the first switching control signal TG_EN_1.

In one or more embodiments, the third transfer control signal TS3 may be directly transmitted to the first transfer transistor TG3L of the third pixel PX3 and transmitted to the second transfer transistor TG3R through a third switching transistor SW3.

In one or more embodiments, the fourth transfer control signal TS4 may be directly transmitted to the first transfer transistor TG4L of the fourth pixel PX4 and transmitted to the second transfer transistor TG4R through a fourth switching transistor SW4.

In one or more embodiments, the third switching transistor SW3 of the third pixel PX3 and the fourth switching transistor SW4 of the fourth pixel PX4 may be controlled by the same switching control signal. For example, the third switching transistor SW3 of the third pixel PX3 and the fourth switching transistor SW4 of the fourth pixel PX4 may be controlled by a second switching control signal TG_EN_2.

Each of the pixels of the pixel group PXGa described with reference to FIG. 2 includes two photoelectric conversion elements. Each of the pixels located in the same row of the pixel group PXGa may be controlled by two transfer control signals and one switching control signal. For example, referring to FIG. 2, the first pixel PX1 and the second pixel PX2 located in a first row of the pixel group PXGa may be controlled by the first transfer control signal TS1, the second transfer control signal TS2, and the first switching control signal TG_EN_1. In addition, the third pixel PX3 and the fourth pixel PX4 located in a second row of the pixel group PXGa may be controlled by the third transfer control signal TS3, the fourth transfer control signal TS4, and the second switching control signal TG_EN_2.

Therefore, in the pixel group PXGa described with reference to FIG. 2, although each of the pixels located in the same row includes two photoelectric conversion elements, the pixels located in the same row of the pixel group PXGa may be controlled through at least three signal lines.

Alternatively, in a case of the selectable related technology, in order to control the transfer transistors of the pixels located in the same row of a pixel group, signal lines may be required at least as many as the number of transfer transistors. For example, in the case of the related technology, in order to control the first pixel PX1 and the second pixel PX2 of the pixel group PXGa of FIG. 2, at least four signal lines may be required as many as the number of transfer transistors TG1L, TG1R, TG2L, and TG2R. Therefore, in the case of the related technology, all transfer transistors TG1L, TG1R, TG2L, TG2R, TG3L, TG3R, TG4L, and TG4R of the four pixels PX1, PX2, PX3, and PX4 located in two rows of the pixel group PXGa of FIG. 2, may be controlled through eight signal lines.

The pixel group PXGa according to one or more embodiments of the present disclosure may control the pixels using fewer signal lines than the related technology. Therefore, the pixel group PXGa according to one or more embodiments of the present disclosure can simplify the arrangement of the signal lines. As a result, during the actual implementation of the image sensor, the manufacturing process and the connection of signal lines can be simplified.

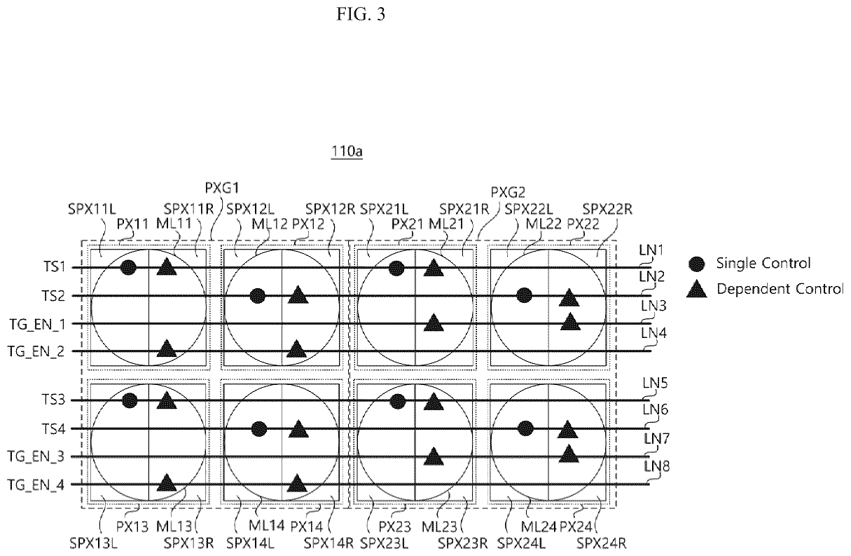

FIG. 3 conceptually shows connections of some transistors and some signal lines of a pixel array according to one or more embodiments of the present disclosure.

For example, FIG. 3 shows the signal lines for supplying the transfer control signal of FIG. 2 and the signal lines for supplying the switching control signal. For convenience of explanation, FIG. 3 does not show the signal lines for supplying the reset control signal RS and the selection signal SEL of FIG. 2.

A pixel array 110a according to the embodiment of FIG. 3 may correspond to the pixel array 110 in FIG. 1. For example, the pixel array 110a of FIG. 3 may be a portion of the pixel array 110 in FIG. 1. A portion of the pixel array 110 of FIG. 1 may have the pixel array 110a of FIG. 3 repeatedly disposed therein.

Signal lines LN1, LN2, . . . , LN8 in the embodiment of FIG. 3 may correspond to the row lines RLn of FIG. 1.

A pixel group of the image sensor 100 according to one or more embodiments of the present disclosure may require additional control signals and/or signal lines to support a plurality of auto focusing modes. For example, in order to support the plurality of auto focusing modes, when the pixel group PXG of FIG. 2 is disposed like the pixel array 110a of FIG. 3, two signal lines may be added for each pixel group.

For example, in order to support the plurality of auto focusing modes, a first pixel group PXG1 may require a second switching control signal TG_EN_2 and a fourth switching control signal TG_EN_4. In order to support the plurality of auto focusing modes, a second pixel group PXG2 may require a first switching control signal TG_EN_1 and a third switching control signal TG_EN_3.

Therefore, the first switching control signal TG_EN_1 and the second switching control signal TG_EN_2 of FIG. 2 may correspond to the second switching control signal TG_EN_2 and the fourth switching control signal TG_EN_4 of FIG. 3 that are connected to the first pixel group PXG1 of FIG. 3. Alternatively, the first switching control signal TG_EN_1 and the second switching control signal TG_EN_2 of FIG. 2 may correspond to the first switching control signal TG_EN_1 and the third switching control signal TG_EN_3 of FIG. 3 that are connected to the second pixel group PXG2 of FIG. 3.

Referring to FIG. 3, the pixel array 110a supporting the plurality of auto focusing modes according to one or more embodiments of the present disclosure will be described.

Referring to FIG. 3, in one or more embodiments, the pixel array 110a may include two pixel groups PXG1 and PXG2. Each of the pixel groups PXG1 and PXG2 may correspond to the pixel group PXGa described with reference to FIG. 2. The pixel groups PXG1 and PXG2 may be pixel groups that are adjacent to each other in the row direction in a matrix form of the pixel array 110a.

Referring to FIG. 3, each of the pixel groups PXG1 and PXG2 may include four pixels. The first pixel group PXG1 may include pixels PX11, PX12, PX13, and PX14, and the second pixel group PXG2 may include pixels PX21, PX22, PX23, and PX24. FIG. 3 exemplarily shows that each of the pixel groups PXG1 and PXG2 includes four pixels, but the present disclosure is not limited to a pixel group including four pixels. For example, in one or more embodiments, a pixel group may include more than four pixels.

Each of the pixels of the pixel groups PXG1 and PXG2 may include two photoelectric conversion elements. A region in which each photoelectric conversion element is located in the pixel may be referred to as a sub-pixel. Each of the pixels of the pixel groups PXG1 and PXG2 may include two sub-pixels. For example, a first pixel PX11 of the first pixel group PXG1 may include a first sub-pixel SPX11L and a second sub-pixel SPX11R. Similarly, each of other pixels other than the first pixel PX11 of the first pixel group PXG1 may also include two sub-pixels.

In order to differently control transistors of the pixel groups PXG1 and PXG2 of FIG. 3 according to each of the plurality of auto focusing modes, eight signal lines LN1, LN2, . . . , LN8 may be arranged. The transistors of the pixel groups PXG1 and PXG2 may receive a control signal through the eight signal lines LN1, LN2, . . . , LN8. The eight signal lines LN1, LN2, . . . , LN8 assume that each of pixel groups PXG1 and PXG2 has four pixels, and according to embodiments, when a pixel group has more than four pixels, more signal lines may be arranged. In the embodiment with reference to FIG. 3, signal lines and control signals will be described on the assumption that each of the pixel groups PXG1 and PXG2 has four pixels.

As used in FIG. 3, a black circle and a black triangle denote that a control signal is transmitted to a sub-pixel corresponding to each of the black circle and the black triangle.

For example, a first signal line LN1 may transmit a control signal to the first sub-pixel SPX11L and the second sub-pixel SPX11R of the first pixel PX11 of the first pixel group PXG1. The black triangle denotes that the control signal is dependently transmitted.

For example, the first transfer control signal TS1 transmitted to the second sub-pixel SPX11R of the first pixel PX11 of the first pixel group PXG1 through the first signal line LN1 may be transmitted to the second sub-pixel SPX11R based on the second switching control signal TG_EN_2 transmitted to the second sub-pixel SPX11R of the first pixel PX11 of the first pixel group PXG1 through the fourth signal line LN4. For example, as described with reference to FIG. 2, the first transfer control signal TS1 may be transmitted to the second sub-pixel SPX11R through a switching transistor controlled by the second switching control signal TG_EN_2.

Similarly, the transfer control signals TS2, TS3, and TS4 transmitted to second sub-pixels SPX12R, SPX13R, and SPX14R of other pixels of the first pixel group PXG1 may also be transmitted to the second sub-pixels SPX12R, SPX13R, and SPX14R based on the second switching control signal TG_EN_2 or the fourth switching control signal TG_EN_4.

For example, the second transfer control signal TS2 may be transmitted to the second sub-pixel SPX12R of the second pixel PX12 of the first pixel group PXG1 based on the second switching control signal TG_EN_2 of the fourth signal line LN4. The third transfer control signal TS3 may be transmitted to the second sub-pixel SPX13R of the third pixel PX13 of the first pixel group PXG1 based on the fourth switching control signal TG_EN_4 of the eighth signal line LN8. The fourth transfer control signal TS4 may be transmitted to the second sub-pixel SPX14R of the fourth pixel PX14 of the first pixel group PXG1 based on the fourth switching control signal TG_EN_4 of the eighth signal line LN8.

Referring to FIG. 3, similar to the first pixel group PXG1, the pixels PX21, PX22, PX23, and PX24 of the second pixel group PXG2 may also directly receive the transfer control signals TS1, TS2, TS3, and TS4 (denoted by a black circle) or receive the transfer control signals TS1, TS2, TS3, and TS4 dependent on the switching control signals (denoted by a black triangle).

In one or more embodiments, signal lines transmitting the switching control signals TG_EN_1 and TG_EN_2 to the pixels PX21, PX22, PX23, and PX24 of the second pixel group PXG2 may be asymmetric with signal lines transmitting the switching control signals TG_EN_1 and TG_EN_2 to the pixels PX11, PX12, PX13, and PX14 of the first pixel group PXG1.

For example, the first pixel PX11 and the second pixel PX12 of the first pixel group PXG1, which are located in the first row of the pixel array 110a, may receive the second switching control signal TG_EN_2 through the fourth signal line LN4. The first pixel PX21 and the second pixel PX22 of the second pixel group PXG2, which are also located in the first row, may receive the first switching control signal TG_EN_1 through the third signal line LN3.

In addition, the third pixel PX13 and the fourth pixel PX14 of the first pixel group PXG1, which are located in the second row of the pixel array 110a, may receive the fourth switching control signal TG_EN_4 through the eighth signal line LN8. The third pixel PX23 and the fourth pixel PX24 of the second pixel group PXG2, which are also located in the second row, may receive the third switching control signal TG_EN_3 through the seventh signal line LN7. The pixel array 110a according to the embodiment of FIG. 3 may transmit the transfer control signal through eight signal lines for each pixel group, and the pixel array 110a may operate the pixel groups in the plurality of auto focusing modes.

For example, the pixel array 110a may each operate the pixel groups PXG1 and PXG2 in first, second, and third auto focusing modes.

In one or more embodiments, the first auto focusing mode may be performed on the basis of a pixel. For example, the pixel signals of all the pixels of the pixel groups PXG1 and PXG2 may be used to perform the auto focusing. The imaging device may perform the auto focusing using the pixel signal output based on each of the plurality of photoelectric conversion elements of each of the pixels. The imaging device may perform the auto focusing using the pixel signal of each of the sub-pixels.

For the first auto focusing mode, depending on the implementation of the operation of the pixel array 110a, the pixel signal based on the photoelectric conversion element of the second sub-pixel may be calculated by subtracting the pixel signal based on the photoelectric conversion element of the first sub-pixel from the pixel signal based on all sub-pixels of the pixel. The subtraction of the pixel signal may be performed by the image signal processor 170 of FIG. 1 at an image signal level.

In one or more embodiments, the second auto focusing mode may be performed on the basis of a pixel group. That is, the pixel group may operate in a binning mode.

For example, the pixel signals of all pixel groups PXG1 and PXG2 may be used to perform the auto focusing. For example, the imaging device may perform the auto focusing using the pixel signal output based on each of the photoelectric conversion elements of the first sub-pixels SPX11L, SPX12L, SPX13L, and SPX14L and the photoelectric conversion elements of the second sub-pixels SPX11R, SPX12R, SPX13R, and SPX14R among the plurality of photoelectric conversion elements of the first pixel group PXG1.

Similarly, the imaging device may perform the auto focusing using the pixel signal output based on each of the photoelectric conversion elements of the first sub-pixels SPX21L, SPX22L, SPX23L, and SPX24L and the photoelectric conversion elements of second sub-pixels SPX21R, SPX22R, SPX23R, and SPX24R in the second pixel group PXG2.

For the second auto focusing mode, depending on the implementation of the operation of the pixel array 110a, the pixel signal based on the photoelectric conversion elements of the second sub-pixels may be calculated by subtracting the pixel signal based on the photoelectric conversion elements of the first sub-pixels from the pixel signal based on all photoelectric conversion elements of the pixels in the pixel group. The subtraction of pixel signals may be performed by the image signal processor of FIG. 1 at the image signal level.

Since the pixel groups operate in the binning mode, the second auto focusing mode may operate at a higher speed than the first auto focusing mode.

In one or more embodiments, the third auto focusing mode may be a mode that performs the auto focusing using the pixel signals of some pixel groups among the pixel groups. The imaging device may perform the auto focusing using a first pixel signal output based on the photoelectric conversion elements of the first sub-pixels of a predetermined one pixel group among the pixel groups and a second pixel signal output based on the photoelectric conversion elements of the second sub-pixels of a predetermined other pixel group. The pixel signals of the pixel groups other than the pixel groups predetermined as the pixel groups used for the auto focusing are not used for the auto focusing. Each of the first sub-pixels and the second sub-pixels may be photoelectric conversion elements located at one side and the other side of each of the pixels in a direction in which rows extend.

For example, in FIG. 3, it may be assumed that the pixel array 110a operates in the third auto focusing mode and the first pixel group PXG1 and the second pixel group PXG2 are predetermined as the pixel groups used for the auto focusing. In this case, the pixel signal of the first sub-pixels SPX11L, SPX12L, SPX13L, and SPX14L of the first pixel group PXG1 and the pixel signal of the second sub-pixels SPX21R, SPX22R, SPX23R, and SPX24R of the second pixel group PXG2 may be used for performing the auto focusing. The pixel signals of the pixel groups other than the pixel groups predetermined as the pixel groups used for the auto focusing are not used for the auto focusing. Therefore, the third auto focusing mode may operate at a higher speed than the first auto focusing mode and second auto focusing mode.

FIGS. 4 to 6 show timing diagrams of an image sensor for reading out pixel signals in different auto focusing modes of the pixel array shown of FIG. 3. Operation methods according to the timing diagrams of FIGS. 4 to 6 may be performed in the pixel array 110a of FIG. 3.

In FIGS. 4 to 6, the image sensor may read out the pixel signal based on a CDS signal. For example, the readout circuit 150 of FIG. 1 may perform counting of a clock signal while the CDS signal remains in a high state. Therefore, the pixel signal may be read out as image data.

Referring to FIG. 2, FIG. 3, and FIG. 4, the operation method of the pixel array 110a in the first auto focusing mode will be described. As described with reference to FIG. 3, the first auto focusing mode may be performed on the basis of a pixel. That is, in the first auto focusing mode, all the pixels of the pixel array 110a may operate similarly to the operation method of FIG. 4.

FIG. 4 will be described assuming a case in which the image signal processor 170 of FIG. 1 calculates the pixel signal based on the photoelectric conversion element of the second sub-pixel of each pixel by subtracting the pixel signal based on the photoelectric conversion element of the first sub-pixel from the pixel signals based on all sub-pixels of the pixel. However, the present disclosure is not limited thereto and may be similarly applied to a case in which the image signal processor 170 calculates the pixel signal based on the photoelectric conversion element of the first sub-pixel of each pixel by subtracting the pixel signal based on the photoelectric conversion element of the second sub-pixel from the pixel signals based on all sub-pixels of the pixel.

FIG. 4 will exemplarily describe operations of the pixels PX11 and PX12 of the first pixel group PXG1 and the pixels PX21 and PX22 of the second pixel group PXG2 that are located in the first row. Operations of the pixels PX13 and PX14 of the first pixel group PXG1 and the pixels PX23 and PX24 of the second pixel group PXG2 that are located in the second row may be similar.

Referring to FIG. 4, at time T0, the reset control signal RS may transition to a high state and remain until time T1. The floating diffusion regions of the first pixel group PXG1 and the second pixel group PXG2 may be reset by the reset control signal RS.

At time T1, the CDS signal transitions to a high state, and the readout circuit 150 of FIG. 1 performs a counting operation, and at time TA when counting is completed, the pixel signal of the reset voltage level may be read out.

At time T3, the first transfer control signal TS1 may transition to the high state. Referring to FIGS. 2 and 3, the transfer transistor of the first sub-pixel SPX11L of the first pixel PX11 of the first pixel group PXG1 and the transfer transistor of the first sub-pixel SPX21L of the first pixel PX21 of the second pixel group PXG2 may be turned on. Photocharges of the first sub-pixel SPX11L of the first pixel PX11 of the first pixel group PXG1 and the first sub-pixel SPX21L of the first pixel PX21 of the second pixel group PXG2 may be transferred to the floating diffusion region.

At this time, the first switching control signal TG_EN_1 and the second switching control signal TG_EN_2 may be in a low state. Therefore, the transfer transistor of the second sub-pixel SPX11R of the first pixel PX11 of the first pixel group PXG1 and the transfer transistor of the second sub-pixel SPX21R of the first pixel PX21 of the second pixel group PXG2 may not be turned on. Therefore, only the photocharges of the sub-pixels located at left sides of the first pixel PX11 of the first pixel group PXG1 and the first pixel PX21 of the second pixel group PXG2 may be transferred to the floating diffusion region.

At time T5, the CDS signal may transition to the high state again, and the readout circuit 150 of FIG. 1 may perform a counting operation, and at time TB when counting is complete, the pixel signal of the voltage level based on the first pixels PX11 and PX21 may be read out. Therefore, the pixel signals based on the photocharges of the sub-pixels located at left sides of the first pixel PX11 of the first pixel group PXG1 and the first pixel PX21 of the second pixel group PXG2 may be read out.

At time T7, the first transfer control signal TS1 may transition to the high state again.

Referring to FIGS. 2 and 3, the transfer transistor of the first sub-pixel SPX11L of the first pixel PX11 of the first pixel group PXG1 and the transfer transistor of the first sub-pixel SPX21L of the first pixel PX21 of the second pixel group PXG2 may be turned on. Photocharges of the first sub-pixel SPX11L of the first pixel PX11 of the first pixel group PXG1 and the first sub-pixel SPX21L of the first pixel PX21 of the second pixel group PXG2 may be transferred to the floating diffusion region.

At this time, the first switching control signal TG_EN_1 and the second switching control signal TG_EN_2 may be in the high state. Therefore, the transfer transistor of the second sub-pixel SPX11R of the first pixel PX11 of the first pixel group PXG1 and the transfer transistor of the second sub-pixel SPX21R of the first pixel PX21 of the second pixel group PXG2 may be turned on by the first transfer control signal TS1. The photocharges of the second sub-pixel SPX11R of the first pixel PX11 of the first pixel group PXG1 and the second sub-pixel SPX21R in the first pixel PX21 of the second pixel group PXG2 may be also transferred to the floating diffusion region. Therefore, the photocharges of all sub-pixels in the first pixel PX11 of the first pixel group PXG1 and the first pixel PX21 of the second pixel group PXG2 may be transferred to the floating diffusion region.

At time T9, the CDS signal may transition to the high state again, and the readout circuit 150 of FIG. 1 may perform a counting operation, and at time TC when counting is complete, the pixel signal of the voltage level based on the first pixels PX11 and PX21 may be read out. Therefore, the pixel signal based on the photocharges of all sub-pixels in the first pixel PX11 of the first pixel group PXG1 and the first pixel PX21 of the second pixel group PXG2 may be read out.

The image signal processor 170 of FIG. 1 may calculate the pixel signal based on the photoelectric conversion element of the second sub-pixel of each of the pixels by subtracting the pixel signal read out at time TB from the pixel signal read out at time TC. Therefore, the image signal processor 170 may generate phase data based on the pixel signal based on the first sub-pixel and the pixel signal based on the second sub-pixel for each of the pixels.

From time T11 to time T21, the pixel signals of the second pixel PX12 of the first pixel group PXG1 and the second pixel PX22 of the second pixel group PXG2 may be read out similarly to the pixel signals of the first pixel PX11 of the first pixel group PXG1 and the first pixel PX21 of the second pixel group PXG2.

However, the pixel signals of the first sub-pixels SPX12L and SPX22L of the second pixels PX12 and PX22 may be read out at time TE based on the second transfer control signal TS2 in a high state, and the pixel signals of all sub-pixels SPX12L, SPX22L, SPX12R, and SPX22R of the second pixels PX12 and PX22 may be read out at time TF based on the second transfer control signal TS2, the first switching control signal TG_EN_1, and the second switching control signal TG_EN_2 that are all in the high state.

The third pixel PX13 of the first pixel group PXG1 and the third pixel PX23 of the second pixel group PXG2 may operate similarly to the first pixels PX11 and PX21. The fourth pixel PX14 of the first pixel group PXG1 and the fourth pixel PX24 of the second pixel group PXG2 may operate similarly to the second pixels PX12 and PX22. Therefore, detailed descriptions will be omitted.

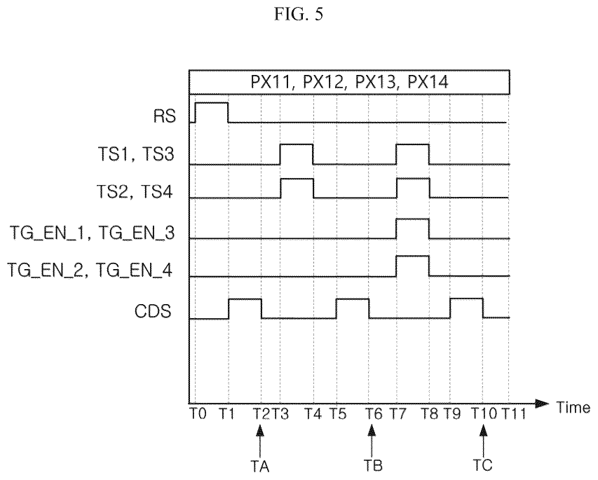

Referring to FIGS. 2, 3, and 5, the operation method of the pixel array 110a in the second auto focusing mode will be described. As described with reference to FIG. 3, the second auto focusing mode may be performed at the pixel group level. That is, in the second auto focusing mode, all pixel groups of the pixel array 110a may operate similarly to the operation method of FIG. 5.

FIG. 5 will be described assuming a case in which the image signal processor 170 of FIG. 1 calculates the pixel signals based on the photoelectric conversion elements of the second sub-pixels of the pixel group by subtracting the pixel signals based on the photoelectric conversion elements of the first sub-pixels from the pixel signals based on all sub-pixels of the pixel group. However, the present disclosure may also be similarly applied to an implementation in which the image signal processor 170 calculates the pixel signal based on the photoelectric conversion elements of the first sub-pixels of the pixel group by subtracting the pixel signal based on the photoelectric conversion elements of the second sub-pixels from the pixel signal based on all sub-pixels of the pixel group.

In FIG. 5, it will be exemplarily described the operation of the pixels PX11, PX12, PX13, and PX14 of the first pixel group PXG1 of FIG. 3. The operation of the pixels PX21, PX22, PX23, and PX24 of the second pixel group PXG2 may also be similar. The operation of the pixels of other pixel groups may also be similar.

Detailed descriptions for parts similar to the description with reference to FIG. 4 will be omitted.

Referring to FIG. 5, at time T0, the reset control signal RS may transition to the high state, and the floating diffusion region of the first pixel group PXG1 may be reset.

At time T1, the CDS signal may transition to the high state, and at time TA when counting is completed, the pixel signal of the reset voltage level may be read out.

At time T3, all of the first, second, third, and fourth transfer control signals TS1, TS2, TS3, and TS4 may transition to the high state. All of the first, second, third, and fourth switching control signals TG_EN_1, TG_EN_2, TG_EN_3, and TG_EN_4 may remain in the low state. Therefore, only the photocharges of the first sub-pixels SPX11L, SPX12L, SPX13L, and SPX14L of all of the pixels PX11, PX12, PX13, and PX14 may be transferred to the floating diffusion region.

At time T5, the CDS signal may transition to the high state again, and at time TB, the pixel signals of the voltage level based on the first sub-pixels SPX11L, SPX12L, SPX13L, and SPX14L of all of the pixels PX11, PX12, PX13, andPX14 may be read out. Therefore, the pixel signal based on the photocharges of the sub-pixels located at left sides of all of the pixels PX11, PX12, PX13, and PX14 may be read out.

At time T7, all of the first, second, third, and fourth transfer control signals TS1, TS2, TS3, and TS4 may transition to the high state again. All of the first, second, third, and fourth switching control signals TG_EN_1, TG_EN_2, and TG_EN_3, and TG_EN_4 may also transition to the high state. Therefore, all the photocharges of the first sub-pixels SPX11L, SPX12L, SPX13L, and SPX14L and the second sub-pixels SPX11R, SPX12R, SPX13R, and SPX14R of all of the pixels PX11, PX12, PX13, and PX14 may be transferred to the floating diffusion region.

At time T9, the CDS signal may transition to the high state again, and the readout circuit 150 of FIG. 1 may read out the pixel signal of the voltage level based on all sub-pixels of the pixels PX11, PX12, PX13, and PX14 at time TC.

The image signal processor 170 of FIG. 1 may calculate the pixel signal based on the photoelectric conversion elements of the second sub-pixels of each of the pixel groups by subtracting the pixel signal read out at time TB from the pixel signal read out at time TC. Therefore, the image signal processor 170 may generate phase data based on the pixel signal based on the first sub-pixels and the pixel signal based on the second sub-pixels of each of the pixel groups.

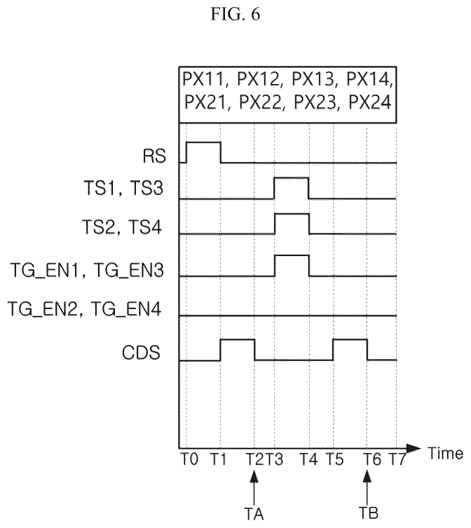

Referring to FIGS. 2, 3, and 6, the operation method of the pixel array 110a in the third auto focusing mode will be described. As described with reference to FIG. 3, the third auto focusing mode may be performed on the basis of a pixel group. That is, in the third auto focusing mode, the pixel groups of the pixel array 110a may operate similarly to the operation method of FIG. 6.

In this case, the pixel signal of the pixel group arranged similarly to the first pixel group PXG1 of FIG. 3 are used for the auto focusing, and the pixel signal of the pixel group arranged similarly to the second pixel group PXG2 may not be used for the auto focusing. For example, the pixel signal of the pixel group in which one sub-pixel of the pixel group is controlled by the first switching control signal TG_EN_1 and the third switching control signal TG_EN_3 may not be used for the auto focusing. The pixel group used for the auto focusing and the pixel group not used for the auto focusing may have different received switching control signals. The image signal processor 170 of FIG. 1 may generate phase data based on the pixel signal of the first pixel group PXG1, and the pixel signal of the second pixel group PXG2 may not be used for generating the phase data.

In FIG. 6, the image signal processor 170 of FIG. 1 may generate the phase data using the pixel signal based on the first sub-pixels of one pixel group and the pixel signal based on the second sub-pixels of the other pixel group. The pixel groups used to generate the phase data may be located in different columns in the matrix.

Detailed descriptions for parts similar to the description with reference to FIGS. 4 and 5 will be omitted. It will be described on the assumption that the pixel signal of the first pixel group PXG1 of FIG. 3 is used for generating phase data, and the pixel signal of the second pixel group PXG2 of FIG. 3 is not used for generating phase data.

Referring to FIG. 6, at time T0, the reset control signal RS may transition to the high state, and the floating diffusion regions of the first pixel group PXG1 and the second pixel group PXG2 may be reset.

At time T1, the CDS signal may transition to the high state, and at time TA when counting is completed, the pixel signal of the reset voltage level may be read out from each of the floating diffusion regions of the first pixel group PXG1 and the second pixel group PXG2.

At time T3, all of the first, second, third, and fourth transfer control signals TS1, TS2, TS3, and TS4 may transition to the high state. The first and third switching control signals TG_EN_1 and TG_EN_3 may transition to the high state. The second and fourth switching control signals TG_EN_2 and TG_EN_4 may remain in the low state.

Therefore, only the photocharges of the first sub-pixels SPX11L, SPX12L, SPX13L, and SPX14L of all of the pixels PX11, PX12, PX13, and PX14 of the first pixel group PXG1 may be transferred to the floating diffusion region. The photocharges of all sub-pixels SPX21L, SPX22L, SPX23L, SPX24L, SPX21R, SPX22R, SPX23R, and SPX24R of the pixels PX21, PX22, PX23, and PX24 of the second pixel group PXG2 may be transferred to the floating diffusion region.

At time T5, the CDS signal may transition to the high state again, and at time TB, the pixel signal of the voltage level based on the first sub-pixels SPX11L, SPX12L, SPX13L, and SPX14L of all of the pixels PX11, PX12, PX13, and PX14 in the first pixel group PXG1 may be read out. In addition, the pixel signal of the voltage level based on all sub-pixels SPX21L, SPX22L, SPX23L, SPX24L, SPX21R, SPX22R, SPX23R, and SPX24R of the pixels PX21, PX22, PX23, and PX24 of the second pixel group PXG2 may be read out.

Therefore, the image signal processor 170 of FIG. 1 may generate phase data based on the pixel signal based on the left sub-pixels of the first pixel group PXG1 and the pixel signal based on the right sub-pixels of another pixel group.

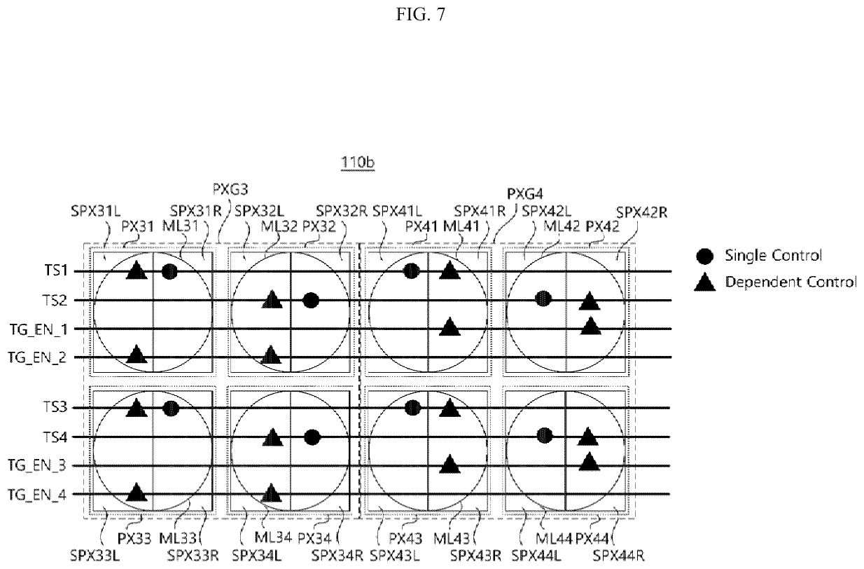

For example, the pixel signal of a third pixel group PXG3 of FIG. 7 may be used as the pixel signal based on the right sub-pixels of the another pixel group. Referring to FIG. 7, the pixel array 110a of FIG. 3 may be located in a portion of the pixel array 110 of FIG. 1 and the pixel array 110b of FIG. 7 may be located in another portion of the pixel array 110 of FIG. 1.

FIG. 7 will be described assuming a case in which the third pixel group PXG3 and a fourth pixel group PXG4 receive the same transfer control signals TS1, TS2, TS3, and TS4 and switching control signals EN_TG_1, EN_TG_2, EN_TG_3, and EN_TG_4 as the first pixel group PXG1 and the second pixel group PXG2. That is, it will be described on the assumption that the third pixel group PXG3 and the fourth pixel group PXG4 are located in the same row as the first pixel group PXG1 and the second pixel group PXG2. However, the present disclosure is not limited thereto, and the third pixel group PXG3 and the fourth pixel group PXG4 may be located in a different row from the first pixel group PXG1 and the second pixel group PXG2. In this case, the third pixel group PXG3 of FIG. 7 may be located in a different column from the first pixel group PXG1 of FIG. 3.

Referring to FIG. 7, pixels PX41, PX42, PX43, and PX44 of the fourth pixel group PXG4 may be controlled by the same transfer control signals TS1, TS2, TS3, and TS4 and switching control signals TG_EN_1 and TG_EN_3 as the pixels PX21, PX22, PX23, and PX24 of the second pixel group PXG2 of FIG. 3.

Alternatively, the sub-pixels of the pixels PX31, PX32, PX33, and PX34 of the third pixel group PXG3 may be controlled by different control signals from the sub-pixels of the pixels PX11, PX12, PX13, and PX14 of the first pixel group PXG1 of FIG. 3.

For example, referring to FIG. 7, the first sub-pixels SPX31L, SPX32L, SPX33L, and SPX34L of the pixels PX31, PX32, PX33, and PX34 of the third pixel group PXG3 may be controlled by one of the control signals TS1, TS2, TS3, and TS4, and one of the second switching control signal EN_TG_2 the fourth switching control signal EN_TG_4. Alternatively, the first sub-pixels SPX11L, SPX12L, SPX13L, and SPX14L of the pixels PX11, PX12, PX13, and PX14 of the first pixel group PXG1 of FIG. 3 may be controlled by one of the control signals TS1, TS2, TS3 and TS4.

Similarly, the second sub-pixels SPX31R, SPX32R, SPX33R, and SPX34R of the pixels PX31, PX32, PX33, and PX34 of the third pixel group PXG3 may be controlled by one of the control signals TS1, TS2, TS3 and TS4. Alternatively, the second sub-pixels SPX11R, SPX12R, SPX13R, and SPX14R of the pixels PX11, PX12, PX13, and PX14 of the first pixel group PXG1 of FIG. 3 may be controlled by one of the control signals TS1, TS2, TS3 and TS4, and one of the switching control signals EN_TG_2 and EN_TG_4.

Therefore, left sub-pixels of the pixels of one of the pixel groups used for generating the phase data in the third auto focusing mode may be controlled by the transfer control signal and the switching control signal. Right sub-pixels of the pixels of the other of the pixel groups used for generating the phase data may be controlled by the transfer control signal and the switching control signal.

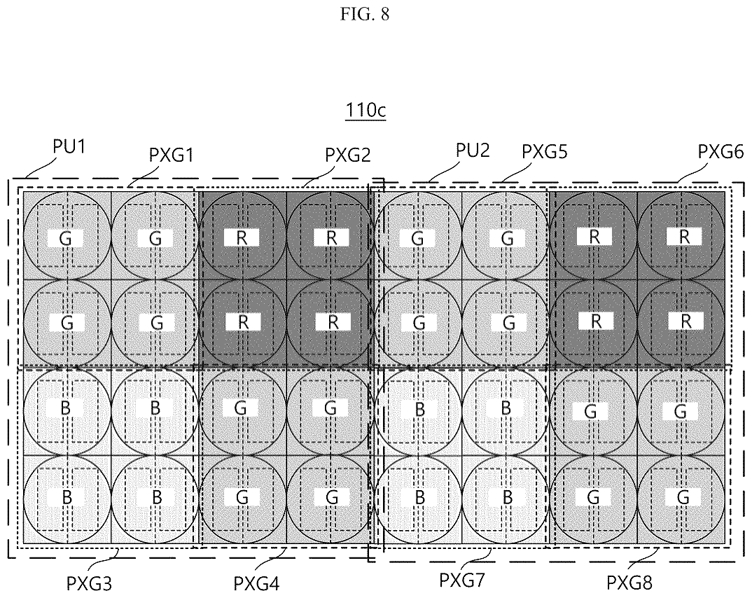

FIG. 8 shows a pixel array 110c according to one or more embodiments of the present disclosure. The pixel array 110c of FIG. 8 may correspond to a portion of the pixel array 110 of FIG. 1. The pixel arrays 110a of FIG. 3 and the pixel arrays 110b of FIG. 7 may correspond to a portion of the pixel array 110c of FIG. 8.

Referring to FIG. 8, the pixel array 110c may include a plurality of pixel units PU1 and PU2. A first pixel unit PU1 may include a plurality of pixel groups PXG1, PXG2, PXG3, and PXG4, and the second pixel unit PU2 may include a plurality of pixel groups PXG5, PXG6, PXG7, and PXG8.

Any one of the pixel groups PXG1, PXG2, PXG3, PXG4, PXG5, PXG6, PXG7, and PXG8 may correspond to any one of the pixel groups PXG1 and PXG2 of FIG. 3 or any one of the pixel groups PXG3 and PXG4 of FIG. 7.

Referring to FIG. 8, in the pixel array 110c, a color filter that transmits light of the same spectrum may be located on the same pixel group. The color filter of a Bayer pattern may be located on the pixel groups in the same pixel unit. However, the present disclosure is not limited to the color filter of the Bayer pattern, and may include various color filter arrangements such as RGBW, RYB, and CMYG.

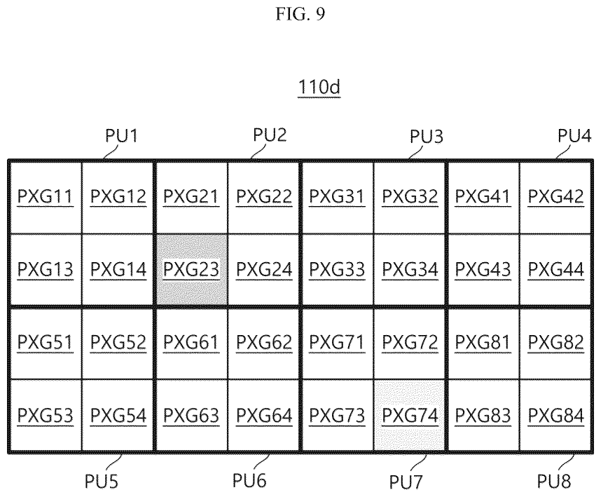

FIG. 9 shows a simplified pixel array according to one or more embodiments of the present disclosure.

The pixel array 110d of FIG. 9 may correspond to a portion of the pixel array 110 of FIG. 1. The pixel arrays 110a of FIG. 3 and the pixel arrays 110b of FIG. 7 may correspond to a portion of the pixel array 110d of FIG. 9.

Referring to FIG. 9, the pixel array 110d may include a plurality of pixel units PU1, PU2, PU3, PU4, PU5, PU6, PU7, and PU8. Each of the plurality of pixel units PU1, PU2, PU3, PU4, PU5, PU6, PU7, and PU8 may include a plurality of pixel groups. For example, each of the plurality of pixel units PU1, PU2, PU3, PU4, PU5, PU6, PU7, and PU8 may include four pixel groups, and the color filter of the Bayer pattern may be located on the pixel groups of the same pixel unit.

In one or more embodiments, the pixel signals based on the first sub-pixels of one pixel group of one pixel unit may be used for generating phase data in the third auto focusing mode. In addition, the pixel signals based on the second sub-pixels of one pixel group of another pixel unit may be used for generating the phase data in the third auto focusing mode.

For example, in the third auto focusing mode, the pixel signals based on the first sub-pixels of a pixel group PXG23 and the pixel signals based on the second sub-pixels of a pixel group PXG74 may be used for generating the phase data. The pixel groups PXG23 and PXG74 used for generating the phase data may be predetermined.

In one or more embodiments, referring to FIG. 9, in the third auto focusing mode, the pixel group PXG23 outputting the pixel signals based on the first sub-pixels used for generating the phase data and the pixel group PXG74 outputting the pixel signals based on the second sub-pixels used for generating the phase data may not be located in the same column in the pixel array 110d.

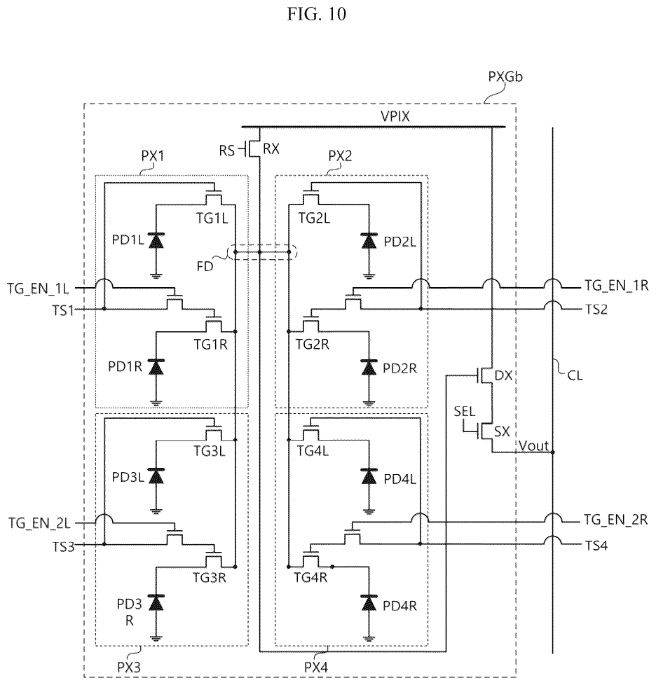

FIG. 10 is a circuit diagram of a pixel group PXGb according to one or more embodiments of the present disclosure. The pixel group PXGb of FIG. 10 may correspond to the pixel group PXG of FIG. 1. A circuit configuration according to one or more embodiments of the pixel group PXGb will be described with reference to FIG. 10. Detailed descriptions of configurations overlapping with or similar to the pixel group PXGa described with reference to FIG. 2 will be omitted. A different configuration from those of the pixel group PXGa of FIG. 2 will be mainly described.

Referring to FIG. 10, unlike the pixel group PXGa of FIG. 2, switching control signals TG_EN_1L and TG_EN_1R supplied to the first pixel PX1 and the second pixel PX2 in the pixel group PXGb are different. That is, the first pixel PX1 and the second pixel PX2 may receive the switching control signals TG_EN_1L and TG_EN_1R through different signal lines.

Similarly, unlike the pixel group PXGa of FIG. 2, switching control signals TG_EN_2L, TG_EN_2R supplied to the third pixel PX3 and the fourth pixel PX4 in the pixel group PXGb are different. That is, the third pixel PX3 and the fourth pixel PX4 may receive the switching control signals TG_EN_2L and TG_EN_2R through different signal lines.

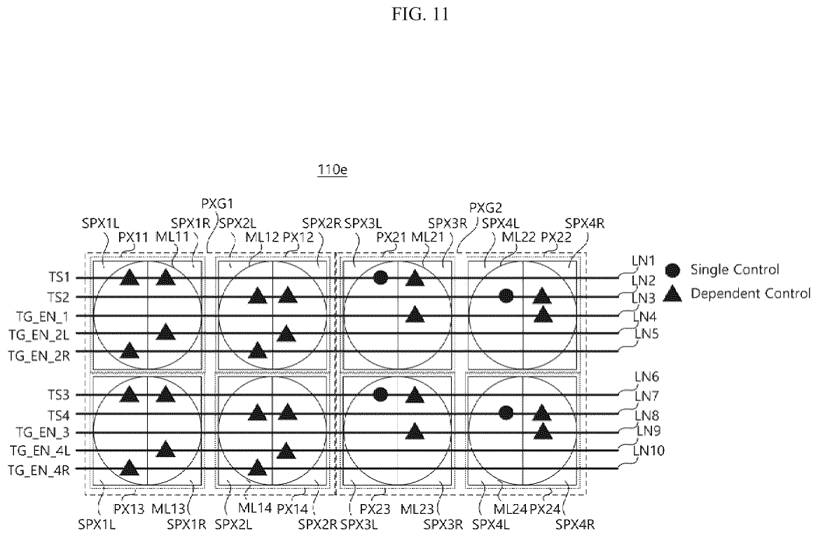

FIG. 11 conceptually shows connections of some transistors and wirings of a pixel array according to one or more embodiments of the present disclosure.

For example, FIG. 11 shows the signal lines through which the transfer control signals of FIG. 10 are supplied and the signal lines through which the switching control signals are supplied. FIG. 11 does not show the signal lines for supplying the reset control signal RS and the selection signal SEL for convenience of explanation.

A pixel array 110e according to the embodiment of FIG. 11 may correspond to the pixel array 110 of FIG. 1.

A configuration according to one or more embodiments of the pixel array PXGe will be described with reference to FIG. 11. Detailed descriptions of configurations overlapping with or similar to the pixel array 110a described with reference to FIG. 3 will be omitted. A different configuration from those of the pixel array 110e of FIG. 3 will be mainly described.

Referring to FIG. 11, in one or more embodiments, each of the pixel groups PXG1 and PXG2 of the pixel array 110e may receive the switching control signals through three signal lines. For example, the first pixel PX11 and the second pixel PX12 of the first pixel group PXG1 and the first pixel PX21 and the second pixel PX22 of the second pixel group PXG2 may receive switching control signals TG_EN_1, TG_EN_2L, and TG_EN_2R respectively through signal lines LN3, LN4, LN5. The third pixel PX13 and the fourth pixel PX14 of the first pixel group PXG1 and the third pixel PX23 and the fourth pixel PX24 of the second pixel group PXG2 may receive switching control signals TG_EN_3, TG_EN_4L, and TG_EN_4R respectively through signal lines LN8, LN9, and LN10.

Unlike what has been described with reference to FIGS. 3, 6, and 7, all of the pixel group outputting pixel signals based on the first sub-pixels and the pixel group outputting pixel signals based on the second sub-pixels that are used for generating phase data in the third auto focusing mode may receive the switching control signals in the same structure as shown in FIG. 11.

Therefore, the embodiment of FIG. 11 may require one more signal line for receiving the switching control signal, unlike the pixel arrays 110a and 110b of FIGS. 3 and 7. However, the pixels may still be controlled using fewer signal lines than the related technology. Therefore, the pixel array 110e according to the embodiment of the present disclosure can simplify the arrangement of the signal lines compared to the related technology. As a result, during the actual implementation of the image sensor, the manufacturing process and the connection of signal lines can be simplified.

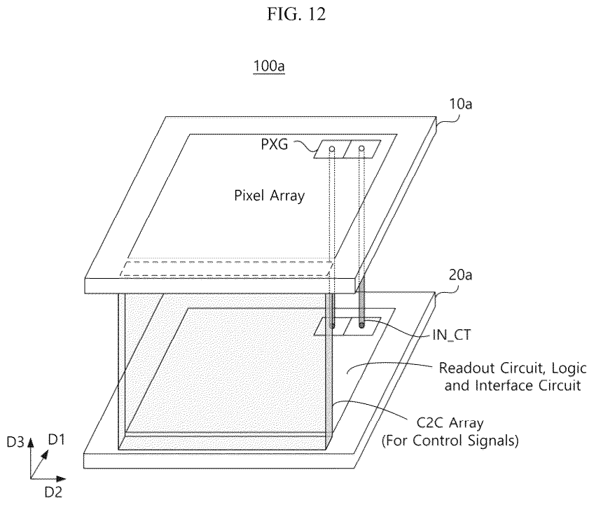

FIG. 12 is a block diagram of an image sensor 100a according to one or more embodiments of the present disclosure. Detailed descriptions for overlapping parts with those described above will be omitted. A pixel group PXG of FIG. 12 may correspond to the pixel group PXG of FIG. 1.

The image sensor 100a may include a first substrate 10a and a second substrate 20a that are stacked. The first substrate 10a and the second substrate 20a may be connected to each other through a wafer bonding process using Cu-to-Cu (C2C) interconnection of a pixel group level. The first substrate 10a and the second substrate 20a may be electrically connected not only through an in-pixel contact IN_CT in the pixel group PXG, but also through a C2C array located in a peripheral region of the substrate. Control signals for controlling a pixel circuit may be transmitted through the C2C array. A pixel signal of the first substrate 10a may be transmitted to a readout circuit of the second substrate 20a through the in-pixel contact IN_CT.

In one or more embodiments, some pixel circuits may be located on the first substrate 10a, and the other pixel circuits may be located on the second substrate 20a.

In one or more embodiments, all of the pixel circuits may be located on the second substrate 20a.

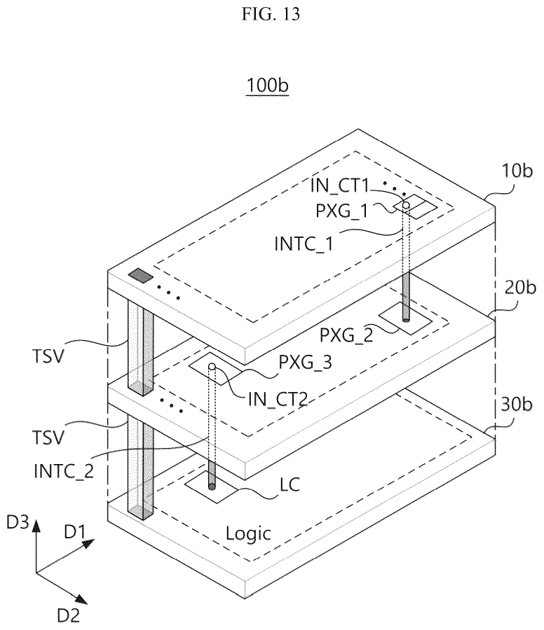

FIG. 13 is a block diagram of an image sensor 100b according to one or more embodiments of the present disclosure. Detailed descriptions for overlapping parts with those described above will be omitted. A pixel group PXG of FIG. 13 may correspond to the pixel group PXG of FIG. 1.

Referring to FIG. 13, the image sensor 100b may include a first substrate 10b, a second substrate 20b, and a third substrate 30b. The third substrate 30b, the second substrate 20b, and the first substrate 10b may be sequentially stacked in a direction D3 perpendicular to a plane (a surface parallel to D1 and D2) of the substrate.

In one or more embodiments, some circuits of the pixel group PXGa of FIG. 2 or the pixel group PXGb of FIG. 10 may be formed on each of the first substrate 10b and the second substrate 20b. A first partial circuit PXG_1 of the pixel group may be located on the first substrate 10b, and a second partial circuit PXG_2 of the pixel group and a third partial circuit PXG_3 may be located on the second substrate 20b. The third substrate 30b may include logic such as a readout circuit, a timing controller, an image signal processor, and an interface circuit. The readout circuit may include an analog digital converter (ADC).

A forms in which circuits configuring the pixel groups PXGa and PXGb are disposed on the first substrate 10b and the second substrate 20b is not limited thereto.

The first substrate 10b and the second substrate 20b may be electrically connected to each other.

In one or more embodiments, the first substrate 10b and the second substrate 20b may transmit a pixel signal or a control signal through a through silicon via TSV located in a peripheral region of the substrate.

In one or more embodiments, the first partial circuit PXG_1 of the pixel group of the first substrate 10b and the second partial circuit PXG_2 of the pixel group of the second substrate 20b may also be electrically connected through a first inter-substrate connection structure INTC_1. The inter-substrate connection structure INTC_1 may be a C2C bonding contact or a deep-contact structure. The deep-contact structure may include the through silicon via TSV. The inter-substrate connection structure INTC_1 may electrically connect an in-pixel contact IN_CT1 electrically connected to an element of the first partial circuit PXG_1 of the pixel group to an in-pixel contact IN_CT2 electrically connected to an element of the second partial circuit PXG_2 of the pixel group.

In one or more embodiments, the first substrate 10b and/or the second substrate 20b may be electrically connected to the third substrate 30b through the through silicon via TSV and/or a second inter-substrate connection structure INTC_2. Signals of the first substrate 10b and/or the second substrate 20b may be transmitted to the readout circuit (or the image signal processor) of the third substrate 30b through the through silicon via TSV and/or the second inter-substrate connection structure INTC_2.

In one or more embodiments, the third partial circuit PXG_3 of the pixel groups PXGa and PXGb may be electrically connected to the circuits of the third substrate 30b through the C2C bonding contact. The second inter-substrate connection structure INTC_2 may include the C2C bonding contact.

In one or more embodiments, the third partial circuit PXG_3 of the pixel group PXGa may be electrically connected to the circuits of the third substrate 30b through a thru-silicon copper (TSC).

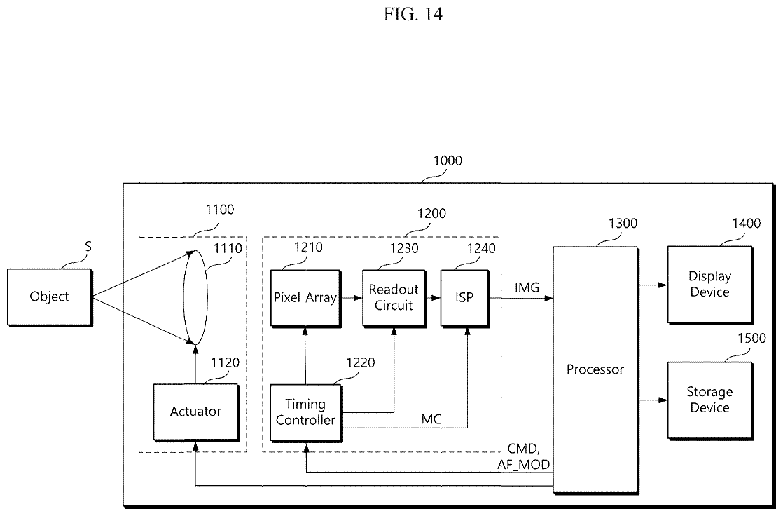

FIG. 14 is a block diagram describing an imaging device 1000 according to one or more embodiments of the present disclosure. Detailed descriptions for overlapping parts with those described above will be omitted.

The imaging device 1000 may include an imaging unit 1100, an image sensor 1200, a processor 1300, a display device 1400, and a storage device 1500.

The processor 1300 may control overall operations of the imaging device 1000. The processor 1300 may control a location of a lens 1110 by providing a control signal to an actuator 1120 which drives lens 1110. As a result, a focal distance may be controlled.

The imaging unit 1100 is a component that receives light and may include the lens 1110 and the actuator 1120. The lens 1110 may include a plurality of lenses.

The actuator 1120 may move the lens 1110 in a direction in which a distance from an object S increases or in a direction in which the distance from the object S decreases based on the control signal of the processor 1300.

The image sensor 1200 may generate image data and phase data based on incident light. The image sensor 1200 may include a pixel array 1210, a timing controller 1220, a readout circuit 1230, and an image signal processor 1240.

Pixels of the pixel array 1210 may include at least one photoelectric conversion elements.

The pixels of the pixel array 1210 according to one or more embodiments of the present disclosure may operate based on a plurality of auto focusing modes. The timing controller 1220 may generate a mode control signal MC based on a control command CMD and an auto focusing mode control signal AF_MOD that are transmitted by the processor 1300. The pixels may operate in any one among the plurality of auto focusing modes.

Each of pixel groups of the pixel array 1210 may be the pixel group described with reference to any one among FIGS. 3, 7, and 11.

The timing controller 1220 may provide the mode control signal MC to the image signal processor 1240. The image signal processor 1240 may process image data based on the mode control signal MC and output the processed image data IMG.

As used herein, processors (e.g., processor 1300 and image signal processor 1240) may be a single or a plurality of processors. A processor may be implemented as a digital signal processor (DSP) processing digital signals, a microprocessor, and a time controller (TCON). However, the disclosure is not limited thereto, and the term processor, as used here, may include one or more of a central processing unit (CPU), a micro controller unit (MCU), a micro processing unit (MPU), a controller, an application processor (AP), a graphics-processing unit (GPU) or a communication processor (CP), and an advanced reduced instruction set computer (RISC) machines (ARM) processor, or may be defined by the terms. Also, as used herein, a processor may be implemented as a system on chip (SoC) having a processing algorithm stored therein or large scale integration (LSI), or in the form of a field programmable gate array (FPGA). As used herein, a processor may perform various functions by executing computer executable instructions stored in memory.

At least one of the components, elements, modules, units, or the like (collectively “components” in this paragraph) represented by a block or an equivalent indication (collectively “block”) in the above embodiments, including the drawings such as FIGS. 1 and 12-14, for example, component such as the row driver, timing controller, readout circuit, output buffer, ramp generator, clock generator, controller, or the like, may carry out the above-described function or functions. These blocks may be physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

An image sensor according to one or more embodiments of the present disclosure can operate in a plurality of auto focusing modes considering accuracy and speed.

According to an image sensor according to one or more embodiments of the present disclosure, a structure of the image sensor can be simplified by reducing the number of wirings controlling pixels.

The above-described contents are specific embodiments for implementing the present disclosure. In addition, the present disclosure will also include technologies that can be modified and implemented using the embodiments discussed herein. Therefore, the scope of the present disclosure should not be limited to the above-described embodiments, but should be defined not only by the patent claims described below but also by the equivalents of the claims recited herein.

What is claimed is:

1. An image sensor comprising:
a pixel array comprising a plurality of pixel groups arranged in a matrix, wherein the pixel array is configured to output a pixel signal;
a row driver configured to transmit a control signal to the plurality of pixel groups; and
a readout circuit configured to output an image signal based on the pixel signal,
wherein a first pixel group of the plurality of pixel groups comprises a plurality of pixels sharing a floating diffusion region,
wherein a first pixel of the plurality of pixels of the first pixel group comprises a first photodiode, a second photodiode, a first transfer transistor, a second transfer transistor, and a switching transistor,
wherein the first transfer transistor and the second transfer transistor are controlled by a transfer control signal, and
wherein the second transfer transistor receives the transfer control signal through the switching transistor.

2. The image sensor of claim 1, wherein the second transfer transistor receives the transfer control signal in a turn-on state of the switching transistor.

3. The image sensor of claim 1,
wherein each of the plurality of pixel groups comprises a plurality of pixels sharing a floating diffusion region,
wherein each pixel of the plurality of pixels of each of the plurality of pixel groups comprises a first photodiode, a second photodiode, a first transfer transistor, a second transfer transistor, and a switching transistor, and
wherein each pixel group of the plurality of pixel groups receives a switching control signal configured to control the switching transistor of each pixel of the plurality of pixels of the pixel group.

4. The image sensor of claim 3, wherein a gate terminal of the second transfer transistor receives the transfer control signal in a turn-on state of the switching transistor based on the switching control signal.

5. The image sensor of claim 3,
wherein the plurality of pixel groups further comprises a second pixel group adjacent to the first pixel group in a row direction in the matrix,
wherein the switching control signal comprises a first switching control signal and a second switching control signal, and
wherein the first pixel group receives the first switching control signal through a first signal line, and the second pixel group receives the second switching control signal through a second signal line.

6. The image sensor of claim 5,
wherein each pixel of the plurality of pixels of the first pixel group and each pixel of the plurality of pixels of the second pixel group comprises a first sub-pixel and a second sub-pixel,
wherein the second sub-pixel of each pixel of the plurality of pixels of the first pixel group receives the first switching control signal, and
wherein the second sub-pixel of each pixel of the plurality of pixels of the second pixel group receives the second switching control signal.

7. The image sensor of claim 6,
wherein the plurality of pixel groups further comprises a third pixel group and a fourth pixel group that are adjacent to each other in the row direction in the matrix,
wherein each pixel of the plurality of pixels of the third pixel group and each pixel of the plurality of pixels of the fourth pixel group comprises a first sub-pixel and a second sub-pixel,
wherein the first sub-pixel of each pixel of the plurality of pixels of the third pixel group receives a third switching control signal,
wherein the second sub-pixel of each pixel of the plurality of pixels of the fourth pixel group receives a fourth switching control signal, and
wherein the third pixel group and the first pixel group are in different columns of the matrix.

8. The image sensor of claim 5,
wherein the plurality of pixels of the first pixel group further comprises a second pixel adjacent to the first pixel in the row direction,
wherein the second pixel group comprises a third pixel and a fourth pixel that are adjacent to each other in the row direction,
wherein the first pixel, the second pixel, the third pixel, and the fourth pixel are each in the same row of the matrix and each comprise a first sub-pixel and a second sub-pixel,
wherein the first sub-pixel of each of the first pixel and the third pixel is configured to output a pixel signal based on a first transfer control signal,
wherein the first sub-pixel of each of the second pixel and the fourth pixel is configured to output a pixel signal based on a second transfer control signal, and
wherein the second sub-pixel of each of the first pixel, the second pixel, the third pixel, and the fourth pixel is configured to output a pixel signal based on one of the first transfer control signal and the second transfer control signal, and one of the first switching control signal and the second switching control signal.

9. The image sensor of claim 8,
wherein the second sub-pixel of the first pixel is configured to output a pixel signal based on the first transfer control signal and the first switching control signal, and
wherein the second sub-pixel of the third pixel is configured to output a pixel signal based on the first transfer control signal and the second switching control signal.

10. The image sensor of claim 8,
wherein the second sub-pixel of the second pixel is configured to output a pixel signal based on the second transfer control signal and the first switching control signal, and
wherein the second sub-pixel of the fourth pixel is configured to output a pixel signal based on the second transfer control signal and the second switching control signal.

11. The image sensor of claim 5, further comprising an image signal processing circuit configured to:
output phase data based on the pixel signal, and
generate phase data based on the pixel signal of the first pixel group and not based on the pixel signal of the second pixel group.

12. The image sensor of claim 3,
wherein the plurality of pixel groups further comprises a second pixel group,
wherein the first pixel group and the second pixel group are in a first row of the matrix and are adjacent to each other in a row direction,
wherein the plurality of pixel groups further comprises a third pixel group and a fourth pixel group located in a second row of the matrix,
wherein the third pixel group and the fourth pixel group are adjacent to each other in the row direction,
wherein each pixel of the plurality of pixels of each of the first pixel group, the second pixel group, the third pixel group, and the fourth pixel group comprises a first sub-pixel and a second sub-pixel,
wherein the second sub-pixel of each pixel of the plurality of pixels of the first pixel group are controlled based on the switching control signal, and
wherein the first sub-pixel of each pixel of the plurality of pixels of the third pixel group are controlled based on the switching control signal.

13. The image sensor of claim 12, wherein the first pixel group and the third pixel group are in different columns of the matrix.

14. An image sensor comprising:
a pixel array comprising a plurality of pixel groups arranged in a matrix, wherein the pixel array is configured to output a pixel signal, and wherein the plurality of pixel groups comprises a first pixel group;
a row driver configured to transmit a control signal to the plurality of pixel groups; and
a readout circuit configured to output an image signal based on the pixel signal,
wherein each of the plurality of pixel groups comprises a plurality of pixels sharing a floating diffusion region,
wherein the plurality of pixels of the first pixel group comprises a first pixel and a second pixel adjacent to each other in a row direction of the matrix,
wherein the first pixel comprises a first photodiode, a second photodiode, a first transfer transistor, a second transfer transistor, and a first switching transistor,
wherein the first transfer transistor and the second transfer transistor are configured to respectively transfer photocharges of the first photodiode and the second photodiode to the floating diffusion region based on a first transfer control signal,
wherein the first switching transistor is configured to provide the first transfer control signal to the second transfer transistor,
wherein the second pixel comprises a third photodiode, a fourth photodiode, a third transfer transistor, a fourth transfer transistor, and a second switching transistor,
wherein the third transfer transistor and the fourth transfer transistor are configured to respectively transfer photocharges of the third photodiode and the fourth photodiode to the floating diffusion region based on a second transfer control signal,
wherein the second switching transistor is configured to provide the second transfer control signal to the fourth transfer transistor,
wherein the first switching transistor and the second switching transistor are controlled by a switching control signal, and
wherein the first transfer control signal and the second transfer control signal are provided by different signal lines.

15. The image sensor of claim 14, wherein the first pixel and the second pixel are located adjacent to each other in a row direction in the pixel array.

16. An image sensor comprising:
a pixel array comprising a plurality of pixel groups arranged in a matrix, wherein the pixel array is configured to output a pixel signal;
a row driver configured to transmit a control signal to the plurality of pixel groups; and
a readout circuit configured to output an image signal based on the pixel signal,
wherein each of the plurality of pixel groups comprises a plurality of pixels sharing a floating diffusion region,
wherein, for each of the plurality of pixel groups, each pixel of the plurality of pixels comprises a plurality of photodiodes and a plurality of transfer transistors, wherein each of the plurality of transfer transistors connects one of the plurality of photodiodes to the floating diffusion region,
wherein, for each of the plurality of pixel groups, the plurality of transfer transistors of each pixel of the plurality of pixels are controlled by a transfer control signal,
wherein, for each of the plurality of pixel groups, one of the plurality of transfer transistors of each pixel of the plurality of pixels is controlled by the transfer control signal, and
wherein, for each pixel of the plurality of pixels of each of the plurality of pixel groups, the transfer control signal is received through a switching transistor.

17. The image sensor of claim 16,
wherein, for each of the plurality of pixel groups, each pixel of the plurality of pixels comprises a first sub-pixel and a second sub-pixel each comprising a photodiode from among the plurality of photodiodes and a transfer transistor from among the plurality of transfer transistors,
wherein, for each pixel of the plurality of pixels of each of the plurality of pixel groups, the first sub-pixel and the second sub-pixel are adjacent to each other in a row direction in the matrix,
wherein, for each pixel of the plurality of pixels of each of the plurality of pixel groups, the transfer transistor of the first sub-pixel is controlled by the transfer control signal, and
wherein, for each pixel of the plurality of pixels of each of the plurality of pixel groups, the transfer transistor of the second sub-pixel is controlled by a transfer control signal received without passing through a switching transistor.

18. The image sensor of claim 17,
wherein the plurality of pixel groups comprises a first pixel group and a second pixel group that are adjacent to each other in a row of the matrix,
wherein the first pixel group comprises a first pixel and a second pixel that are adjacent to each other in a row of the matrix,
wherein the second pixel group comprises a third pixel and a fourth pixel that are located adjacent to each other in a row of the matrix,
wherein the second pixel and the third pixel are adjacent to each other, and
wherein a signal line supplying a switching control signal to the first pixel differs from a signal line supplying the switching control signal to the third pixel.

19. The image sensor of claim 18, wherein a signal line supplying the switching control signal to the second pixel differs from a signal line supplying the switching control signal to the fourth pixel.

20. The image sensor of claim 18,
wherein a signal line supplying the transfer control signal to the first pixel differs from a signal line supplying the transfer control signal to the second pixel, and
wherein a signal line supplying the transfer control signal to the third pixel differs from a signal line supplying the transfer control signal to the fourth pixel.
